(19) United States
(12) Patent Application Publication
(10) Pub. No.: US 2019/0235624 A1
(43) Pub. Date: Aug. 1, 2019

(54) SYSTEMS AND METHODS FOR PREDICTIVE VISUAL RENDERING

(71) Applicant: SUPEREYE, INC., Phoenix, AZ (US)

(72) Inventors: Jeffrey Louis GOLDBERG, San Diego, CA (US); Abraham M. SHER, Bel Harbour, FL (US); Daniel A. BOCK, Paradise Valley, AZ (US); Alfredo DUBRA, Phoenix, AZ (US)

(73) Assignee: Supereye, Inc., Phoenix, AZ (US)

(21) Appl. No.: 16/319,291

(22) PCT Filed: Jul. 19, 2017
(86) PCT No.: PCT/US2017/042915

§ 371 Date: Jan. 18, 2019

Related U.S. Application Data
(60) Provisional application No. 62/364,305, filed on Jul. 19, 2016.

(51) Int. Cl. G06F 3/01; G02B 27/01; G06T 7/277

(52) U.S. Cl. CPC G06F 3/013; G02B 27/0172; G02B 27/0101; G02B 27/0179; G06T 2207/30201; G02B 2027/0187; G02B 2027/0138; G02B 2027/0178; G06T 7/277

(57) ABSTRACT

A method of displaying information to a user includes: tracking the user's eye to obtain information about the time-varying physiology of the user's eye; correlating the information about the time-varying physiology of the user's eye to information about the user's field of view; predicting where the user will look at a future time based on the correlation; and displaying to the user's eye, at the future time, information related to one or more objects in the user's field of view based on the prediction.

### CROSS-REFERENCE TO RELATED APPLICATIONS

This application claims the benefit under 35 U.S.C. § 119(e) of U.S. Patent Application No. 62/364,305, entitled “Systems and Methods for Providing an Enhanced Visual Image”, filed Jul. 19, 2016, which is incorporated herein by reference in its entirety.

### FIELD

The present specification is related generally to systems for creating and delivering visual interfaces, and particularly to a system that tracks the movement and focus of a person's eyes, and uses information generated from the tracking to provide an enhanced visual interface to the person.

### BACKGROUND

Vision begins when light rays are reflected off an object and enter the eyes through the cornea, the transparent outer covering of the eye. The cornea bends or refracts the rays that pass through an approximately round aperture called the pupil. The iris, or colored portion of the eye that surrounds the pupil, opens and closes (making the pupil bigger or smaller) to regulate the amount of light passing through. The light rays then pass through the lens, which can change shape to further bend the rays and focus them on the retina at the back of the eye. The cells in the retina convert the light into electrical impulses that the optic nerve sends to the brain.

The eye does not take single snapshots of what it sees, but collects something akin to a video stream that is sent to the brain for processing into complete visual images. This video stream, however, is limited in its data content, and most of the signal processing is conducted by the brain to assemble and provide the user's visual perception and interpretation of what they are viewing. For instance, the human brain combines the signals from two eyes to increase resolution and to provide spatial information through triangulation. The visual system also processes other visual cues such as light, distance/depth, color (through light/spectral capture), contrast and temperature. Visual neuroscience focuses on the study of this visual system, aiming to understand how neural activity results in visual perception and behaviors dependent on vision.

Tracking methods may be used to measure the point of gaze and/or the rotation of one or both eyes relative to the head. Devices that aid the process of tracking these rotations are called eye trackers. Such devices are used in research on the visual system, in psychology, in psycholinguistics, marketing, as an input device for human computer interaction, and in product design, for example. Human-computer interactions include virtual reality and augmented reality applications. Virtual reality generally refers to a computer-generated simulation of a three-dimensional image or environment that can be interacted with in a seemingly real or physical way by a person using special electronic equipment, such as a helmet with a screen inside or gloves fitted with sensors. Augmented reality generally refers to technology that superimposes a computer-generated image on a user's view of the real world, thus providing a composite view.

One application of eye tracking is in the use of wearable devices, such as glasses to enhance a person's vision, or the virtual reality helmet described above. Using an eye tracker mounted on the wearable, the device can determine if the user is looking at a particular object, can capture an image of the object using a camera, identify the object using an image recognition algorithm, look up information about the recognized object, and then overlay that information on the object in the user's field of view using a display in the glasses worn by the user. Thus, a person looking at and object such as a vase could almost immediately learn that the vase is, for example, an antique vase via a visual overlay of information.

Eye tracking devices can use a variety of different methods for their purpose. For example, some methods attach an object (such as a contact lens) to the eye; use a non-contact optical technique to measure eye-movement; or measure electric potentials using electrodes placed around the eyes.

Many eye-tracking methods involve non-contact optical imaging. Typically, video-based eye trackers use one or more cameras focused on one or both eyes to record their movement as the viewer looks at some stimulus. Some eye-trackers follow the pupil boundary and also use infrared/near-infrared light to create corneal reflections. The vector between the pupil center and the corneal reflections can be used to compute the point of visual focus or the gaze direction. Bright-pupil, dark-pupil, and passive-light techniques are based on infrared or active, and passive light, respectively. Their difference is based on the location of the illumination source with respect to the optics and the type of light used.

Eye-tracking setups can be head-mounted or not. Those setups that are not head mounted may require the subject's head to be stable, or may additionally include components for automatically tracking the head during motion.

### SUMMARY

Many conventional augmented and virtual reality systems that utilize eye-tracking rely on extremely rapid processing to present information to a user based on where they are currently looking. Even with powerful processors, such systems can suffer from lag where the processing and rendering engines are unable to keep pace with the user such that the displayed objects overlaid on the actual or virtual environments are rendered too slowly to keep pace with environmental changes. The result is often an unsatisfying user experience.

Predictive rendering involves displaying information to a user in anticipation of where they are about to look. Predictive rendering can be used to ensure that the information is displayed “on time”, rather than later, thereby rendering with “zero lag time”. The prediction is based on information about the time-varying physiology of the user's eye, including where the user is currently looking and the history of their eye motion, including both voluntary and involuntary eye motion. Advances in visual neuroscience also allows the eye motion to be correlated to other factors that relate to the user's visual perception, including the user's emotional state and level of fatigue. Accordingly, disclosed systems utilize predictive rendering to present information in virtual or augmented reality environments that can be both substantially lag free and relevant to the user's environment and mental state.

Various aspects of the invention are summarized as follows.

In general, in a first aspect, the invention features a method of displaying information to a user that includes: tracking the user's eye to obtain information about the time-varying physiology of the user's eye; correlating the information about the time-varying physiology of the user's eye to information about the user's field of view; predicting where the user will look at a future time based on the correlation; and displaying to the user's eye, at the future time, information related to one or more objects in the user's field of view based on the prediction.

Implementations of the method can include one or more of the following features and/or features of other aspects. For example, predicting can additionally be based on information about the user's visual perception of the user's field of view (e.g., information related to voluntary and/or involuntary eye movements that correlate to a mental state of the user, such as whether they notice objects in their field of view, they emotional state, and/or they level of fatigue or awareness). Predicting can also include using a predictive algorithm. For example, the algorithm can include Bayesian filtering, Kalman filtering, sequential Monte Carlo sampling (e.g., particle filtering), mean shift procedures, dead reckoning, or alpha-beta-gamma predictors.

Tracking the user's eye can include acquiring a sequence images of the user's eye and determining, from the images, information selected from the group consisting of: gaze coordinates (e.g., 2D); eye coordinates (e.g., x, y, z of the pupil center); pupil data (e.g., area, diameter); and eyelid movements. Tracking the user's eye can include identifying Purkinje reflections in the sequentially-acquired images and tracking the motion of the Purkinje reflections. Both of the user's eyes can be tracked.

Obtaining information about the time-varying physiology of the user's eye can include identifying physiological events and status of the user's eye based on the information determined from the sequential images. The physiological events and status can include voluntary or involuntary eye movements. For example, the physiological events and status can include events and status selected from the group consisting of: gaze events (e.g., fixations, saccades, microsaccades, glissades); gaze vectors; vergence; distance of point of gaze; pupil dilation; and blink events (e.g., intentional blinking, physiological blinking).

The images of the user's eye can be acquired at a frame rate sufficient to track microsaccades and nystagmus of the user's eye, for example at a frame rate of 24 frames-per-second or greater, or at a frame rate in a range from 24 frames-per-second to 100 frames-per-second. The images can be analyzed line-by-line to provide the information about the time-varying position of the eye.

In some embodiments, correlating the information about the time-varying physiology of the user's eye to the user's field of view can include acquiring a sequence of images of the user's field of view and correlating one or more objects in each image of the user's field of view to physiological events and status of the user's eye at the corresponding time. Correlating the one or more objects can include identifying, at each corresponding time, an object that is a subject of the user's gaze and/or one or more objects that are in the user's peripheral vision. Predicting where the user will look at the future time can include predicting which of the objects will be the subject of the user's gaze at the future time and which of the objects will be in the user's peripheral vision at the future time. The information displayed to the user's eye at the future time can include information related to the object predicted to be the subject of the user's gaze or in the user's peripheral vision at the future time. Where the user will look at a future time can be predicted based on the identified physiological events and status of the user's eye.

The objects in each image of the user's field of view can be virtual objects rendered by an electronic display or real objects. Displaying the information to the user's eye can include overlaying images with one or more objects in the user's field of view. The displayed information can enhance the one or more objects in the user's field of view.

The information is displayed can be based on contextual user information in addition to the prediction. The contextual user information can be derived from one or more images of the user's field of view and can include information about the user's activity contemporaneous to displaying the image. (e.g., driving, gaming, playing sports, shopping, engaging in work, etc.) The information can be displayed to the user's eye in a virtual reality or augmented reality environment.

The method can be implemented using a device selected from the group consisting of: a laptop computer; a tablet computer; a mobile phone; a personal computer; a personal data assistant; a smartphone; a head mounted display; and a heads-up display.

Tracking the user's eye can include determining lens wobble for the user's eye and displaying the information can include stabilizing a displayed image to compensate for the lens wobble.

In general, in a further aspect, the invention features a system that includes an electronic display module arranged to display information to a user's eye related to one or more objects in the user's field of view during operation of the system; an eye-tracking module arranged to obtain information about a time-varying physiology of the user's eye during operation of the system; and an electronic control module in communication with the electronic display module and the eye-tracking module, the electronic control module being programmed to: (i) correlate the information about the time-varying physiology of the user's eye from the eye-tracking module to the user's field of view; (ii) predict where the user will look at a future time based on the correlation; and (iii) cause the electronic display module to display to the user's eye, at the future time, information related to one or more objects in the user's field of view based on the prediction.

Embodiments of the system can include one or more of the following features and/or may be configured to perform the methods of the first aspect discussed above.

The electronic control module can be further programmed to predict where the user will look based on information about the user's visual perception of the user's field of view. It can also be programmed to use a predictive algorithm for the prediction. For example, the algorithm can include Bayesian filtering, Kalman filtering, sequential Monte Carlo sampling (e.g., particle filtering), mean shift procedures, dead reckoning, or alpha-beta-gamma predictors.

The system can also include an image capture module arranged to acquire a sequence of images of the user's field of view. For example, the image capture module can include one or more image sensors arranged to capture an image of the user's field of view during use of the system.

Information related to one or more objects in the user's field of view can include information related to the object predicted to be the subject of the user's gaze or peripheral vision at the future time. The objects in each image of the user's field of view can be virtual objects rendered by an electronic display or real objects.

The eye-tracking module can include an image sensor arranged to acquire a sequence of images of the user's eye. From the images of the user's eye, the electronic control module be programmed to determine information selected from the group consisting of: gaze coordinates (e.g., 2D); eye coordinates (e.g., x, y, z of the pupil center); pupil data (e.g., area, diameter); and eyelid movements. The eye-tracking module can also be arranged to obtain information about both of the user's eyes.

Information about the time-varying physiology of the user's eye can include physiological events and status of the user's eye based on the information determined from the sequential images. The physiological events and status can include voluntary or involuntary eye movements. For example, the physiological events and status can include events and status selected from the group consisting of: gaze events (e.g., fixations, saccades, microsaccades, glissades); gaze vectors; vergence; distance of point of gaze; pupil dilation; and blink events (e.g., intentional blinking, physiological blinking).

The image sensor can be arranged to acquire a sequence of images at a frame rate sufficient to track microsaccades and nystagmus of the user's eye, or at a frame rate of 24 frames-per-second or greater, or at a frame rate in a range from 24 frames-per-second to 100 frames-per-second.

The electronic control module can be programmed to analyze the images line-by-line to obtain the information about the time-varying position of the eye.

The electronic control module can be programmed to correlate one or more objects in each image of the user's field of view to physiological events and status of the user's eye at the corresponding time. It can be further programmed to identify, at each corresponding time, an object that is a subject of the user's gaze and/or one or more objects that are in the user's peripheral vision. The module can be programmed to predict which of the objects will be the subject of the user's gaze at the future time and which of the objects will be in the user's peripheral vision at the future time. The electronic display module can be configured to overlay images with one or more objects in the user's field of view or enhance the one or more objects in the user's field of view.

In some embodiments, the electronic control module is programmed to predict where the user will look at a future time based on the identified physiological events and status of the user's eye. The electronic control module can also be programmed to predict where the user will look at a future time based on contextual user information. The contextual user information can be derived from one or more images of the user's field of view. For example, the contextual user information can include information about the user's activity contemporaneous to displaying the image. (e.g., driving, gaming, playing sports, shopping, engaging in work, etc.)

The system can be programmed to identify the Purkinje reflections in the sequentially-acquired images and to track the motion of the Purkinje reflections.

The system can be arranged to operate in a virtual reality environment or an augmented reality environment.

The system can additionally include a wearable device (e.g., eyeglasses, a helmet, a headset) having one or more digital image sensors.

The electronic control module can include a FPGA or ASIC arranged to process signals from the eye-tracking module. The electronic control module can further include a central processing unit arranged to process signals from the FPGA or ASIC.

The electronic display module can include a head-mounted display, which can include a wearable device (e.g., eyeglasses, a helmet, a headset).

The electronic display module can include a projector arranged to direct projected light to a reflector positioned in an eyepiece of the wearable device, the reflector being arranged to reflect the projected light to the user's eye to present the images to the user's eye. The electronic display module can include a projector arranged to direct projected light to a waveguide positioned in an eyepiece of the wearable device, the waveguide being arranged to direct the projected light to the user's eye to present the images to the user's eye.

The system can include a wearable device (e.g., eyeglasses, a helmet, a headset) including the image sensor of the eye-tracking module.

The system can be integrated into a motor vehicle that can include a steering wheel, a windshield, a dashboard, and side windows. The user's field of view can include the scene observable to a driver through the vehicle's windshield and windows. The eye-tracking module can be embedded in the steering wheel or the dashboard of the vehicle. The image capture module can be embedded in the steering wheel or dashboard of the vehicle. The display module can project images onto the windshield of the vehicle. The display module can also be a heads-up display attached to the dashboard and positioned in front of the windshield.

In certain embodiments, the electronic display module can include a display of a device selected from the group consisting of: a laptop computer; a tablet computer; a mobile phone; a personal computer; a personal data assistant; or a smartphone. The eye-tracking module can be arranged to face the user of the display (e.g., embedded in the bezel or elsewhere in the display).

Among other advantages, the disclosed techniques can allow for a more natural and pleasing virtual reality or augmented reality experience compared to conventional techniques. For example, using predictive rendering based on eye tracking can result in an augmented reality experience in which virtual objects are displayed to a user with greater overlay precision relative to the user's environment compared to conventional technologies. The overlay precision is achieved because the system is able to accurately anticipate where the user's vision will be focused at a future time, rather than simply trying to display an image based on the real-time information about the user's environment and gaze vector. Neuroscience information can also be used to enhance predictive rendering.

More generally, the disclosed techniques can be applied to other environments beyond virtual reality and augmented reality. For example, the disclosed techniques can be applied to activities like watching television, online browsing (e.g., viewing commercial websites/apps and/or social media websites/apps). The techniques can also be applied to hand-free use of computers (e.g., by quadriplegics) through eye gestures.

In addition to providing a more pleasing user experience, predictive rendering can have further benefits. For example, lower imaging and/or computing power can be used to achieve the pleasing experience than approaches that rely on reducing any lag time between tracking the eye and displaying an object based on the tracked eye. The reduction in imaging and/or computing power can be achieved because the systems rely on the predictive rendering to overcome lag, rather than using maximal computing power to reduce lag. Accordingly, predictive rendering can result in longer battery life and/or less sophisticated imaging and/or computing components that may otherwise be necessary.

The disclosed eye tracking systems can employ image analysis techniques to identify the location of the pupil and Purkinje reflections at a substantially faster rate than the existing methods. In certain embodiments, the system allows for improved identification of rapid eye movements as well as saccades and microsaccades. This decreases latency between eye movement and the system responding to that movement.

Disclosed systems can use eye tracking data, including the location of the pupil and Purkinje reflections P1/P2 and P3/P4, to determine a degree of “lens wobble” for the eye.

In some embodiments, disclosed systems and methods use saccades and/or microsaccades to continuously update a coordinate system between eye tracking data and analysis of what the eye is fixated on.

Alternatively, or additionally, the systems and methods can use pupil size and changes in pupil size to determine whether the eye is fixating on near or far objects.

Eye tracking systems can be integrated with an enhanced reality visual interface in the form of smart eyeglasses that view, process, and project desired visual information to a user's field of view.

In certain embodiments, eye tracking data is processed to determine a movement of an eye in a manner that includes analyzing an image on a line-by-line basis and filtering lines of frame data. The line-by-line acquisition, analysis and filtering is repeated until analysis of the image is complete.

The frame rate for video acquisition and/or rendering can vary. For example, frame rates from 24 Hz to 100 Hz or more can be used.

In some embodiments, eye tracking data includes at least one of a location of a pupil of the eye, a location of Purkinje reflections P1/P2, and a location of Purkinje reflections P3/P4. Determining the location of a pupil of the eye can include calculating a difference between a current location of a portion of the pupil in a line of frame data and a previous location of the portion of the pupil in the corresponding line of frame data.

The pupil size can be used to determine whether the eye is fixating on near or far objects. Changes in the pupil size and the relative position of both eyes, e.g. interpupillary distance, can be used to determine whether the eye is fixating on near or far objects.

In some embodiments, the methods can include creating a coordinate map of the eye. The repeated line-by-line analysis can include comparing against a continuously updated coordinate map of eye locations. In certain cases, saccades and microsaccades can be employed to continuously update the coordinate map of eye locations.

Output of the filtering process can include eye tracking data. The output can be delivered to an image processing module.

The methods can result in a reduced latency between eye movement and a system responding to the eye movement. This reduced latency can be experienced in image processing and eye gaze computations.

In certain embodiments, each line of frame data is a portion of video frame captured by an optical sensor. The optical sensor can be a CMOS sensor, e.g., that senses an infrared component of light reflected from said eye.

In some embodiments, the methods can include stabilizing an image by tracking lens wobble for an individual. Lens wobble tracking can be accomplished by tracking a change in distance between P1/P2 and P3/P4, using pupil movement information to filter any change due to eye rotation, and digitally stabilizing the image using the changed distance and pupil movement.

The aforementioned and other embodiments of the present shall be described in greater depth in the drawings and detailed description provided below.

### BRIEF DESCRIPTION OF THE DRAWINGS

These and other features and advantages of the present specification will be further appreciated, as they become better understood by reference to the detailed description when considered in connection with the accompanying drawings:

FIG. 1 is a schematic of an embodiment of a visual interface system arranged to use eye tracking for predictive rendering.

FIG. 2 is a flowchart showing steps in the operation of the system shown in FIG. 1 for predictive rendering.

FIG. 3 is a flowchart showing one method of eye tracking.

FIG. 4 is a flow chart illustrating an exemplary mapping function performed by the system to enhance an image of an object of interest to the user.

FIG. 5 is a flowchart detailing a method of determining lens wobble and stabilizing an image based on the determined wobble information using predictive rendering.

FIGS. 6A-6B are schematic diagrams illustrating two possible applications of predictive rendering in a visual interface system, wherein FIG. 6A shows an embodiment for warning a user about an approaching object, and FIG. 6B shows an embodiment for improving information overlays for an object.

FIGS. 7A-7B are schematics of a visual interface system for predictive rendering in the form of eyeglasses, wherein FIG. 7B is an enlarged view of a portion of the eyeglasses of FIG. 7A.

FIGS. 8A-8B are schematics of a visual interface system for predictive rendering in the form of a head-mounted display embedded in a helmet, wherein FIG. 8B is an enlarged view of a portion of the head mounted display of FIG. 8A.

FIG. 9 is a schematics of a visual interface system for predictive rendering in the form of a dashboard heads up display.

FIG. 10 is a schematic of a visual interface system for predictive rendering in the form of a computer screen display.

FIG. 11 is schematic diagram of an example computer system.

Like reference numbers and designations in the various drawings indicate like elements.

### DETAILED DESCRIPTION

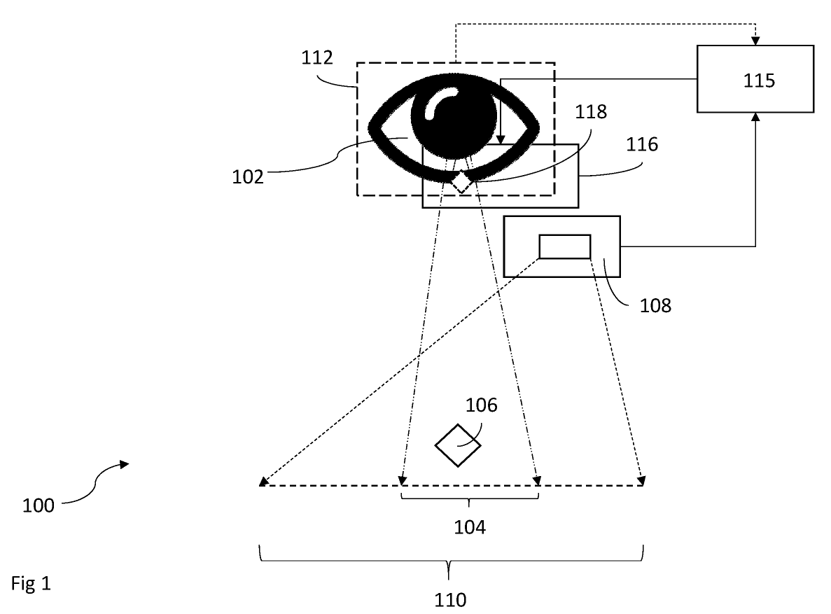

Referring to FIG. 1, a visual interface system 100 for a user's eye 102 includes first and second image capture devices 108 and 112, respectively, electronic processing module 115, and a display device 116. As depicted, user's eye 102 has a corresponding field of view 104, which is characterized by a solid angle within which objects in direct line of sight are visible to the user. Field of view 104 varies as user's eye 102 and/or head moves.

During operation, first image capture device 108 captures images of a corresponding field of view 110, which overlaps with user's field of view 104. As depicted, the field of view of first image capture device 108 is larger than the field of view of user's eye 102 to ensure that the first capture device 108 captures every object in the user's field of view. Accordingly, a physical object 106 that is in the user's field of view 104 is also in the captured field of view 110.

Image capture device 112 is an eye-tracking device which captures raw eye data, which includes a sequence of images of the eye over time. The images are used by system 100 to track the movement of the eye 102 and from which the system determines foveal and peripheral fields of focus of eye 102.

Electronic processing module 115 receives signals from and/or transmits signals to image capture devices 108 and 112 and display device 116. Among other functions, electronic processing module 115 tracks eye 102 based on signals from image capture device 112, correlates information from the eye tracking with image information about the user's field of view from image capture device 108, and delivers instructions and information to the display device 116. Using a predictive rendering algorithm (details below), display device 116 displays a virtual object 118 to the user's eye 102, overlaying the virtual object with physical object 106 in the user's field of view.

Image capture devices 108 and 112 typically include at least one image sensor, e.g., as part of a digital camera. The image sensors may be semiconductor charge-coupled devices (CCD), complementary metal-oxide-semiconductor (CMOS) devices (e.g., using active pixel sensors), and/or may use N-type metal-oxide-semiconductor (NMOS, Live MOS) technologies. The image capture devices also generally include optical components that provide a desired field of view in combination with the sensor. Wide angle lenses or panoramic lenses can be used. Accordingly, the field of view for one or both of the image capture devices can be 180 degrees or more in one or both dimensions. For example, in some embodiments, field of view 110 can be up to 360 degrees depending on application.

Both capture device 108 and capture device 112 are video capture devices, which acquire a sequence of frames of field of view 110 and eye 102, respectively, over a period of time.

In general, a variety of display devices can be used depending on the application. For example, display device 116 can be a direct view display or a projection display. Display device can be a color display or a monochrome display. Exemplary types of display include OLED displays, LCDs, micro LED displays, or quantum LEDs. Projection displays can include pico-projection display devices that use an array of light-emitting diodes as pixels for a video display suitable for projection into the eye 102 or on a screen. In general, the projection display has sufficient resolution to project (e.g., through an optical or digital waveguide) virtual object 118 directly to the user's eye 102 or onto a screen (e.g., a planar screen) in front of the eye.

Generally, virtual object 118 includes information relevant to the physical object 106. For example, this can include information retrieved from some other source (e.g., over the internet) based on recognition by system 100 of physical object 106, e.g., if physical object 106 is a person's face, virtual object 118 can include information about that person, such as their name. In some embodiments, virtual object 118 includes information that highlights physical object 106 to the user. For instance, virtual object 118 can be an outline of physical object 106 in a color that draws the user's attention. Overlaying the virtual object 118 includes positioning the information proximate to the physical object in the user's field of view, e.g., just next to or over the physical object, so that the user associates the information with the physical object.

Electronic processing module 115 generally includes electronic components that receive signals from and/or transmit signals to image capture devices 108 and 112 and display device 116, in addition to electronic processors and memory devices used to store and process the signals. Examples of such components include central processing units (CPUs), general processing units (GPUs), application specific integrated circuits (ASICs) and field programmable gate arrays (FPGAs).

While electronic processing module 115 is depicted in FIG. 1 as a single element, the components forming the module can generally be integrated into a single housing or distributed over a network. For example, where system 100 includes a head mounted apparatus (e.g., a helmet, goggles, eyeglasses, or headset), at least some of the components of electronic processing module 115 can be integrated with the head mounted apparatus, while other components are housed elsewhere (e.g., as part of a mobile device, like a smartphone). Alternatively, or additionally, in some embodiments, components of electronic processing module 115 can be distributed over a wider network, such as the internet. For example, one or more components can be housed on a server, remote from user.

While system 100 is depicted in FIG. 1 for a single eye 102, the system can be used to track and display information to both eyes using additional eye tracking and display devices.

Accordingly, electronic processing module can include wireless and/or wired receivers and transmitters (not shown) capable of sending and transmitting data between different components of system 100 or over wider networks, such as the internet.

System 100 can include other sensors for providing additional information to electronic processing module 115. For example, system 100 can include accelerometers, gyroscopes, magnetometers, and/or GPS sensors for providing information about position, motion, and/or location of the user. For instance, where system 100 interfaces with a smartphone, the system can use any of the sensors available on the smartphone to provide additional information useful for the predictive rendering algorithm.

As described above, system 100 is an augmented reality system in which display device 116 displays virtual image 118 to the user's eye 102 as an overlay of a physical object 106 contemporaneously observed by the user through the display device. In other words, the portion of display device in the user's field of view can be transparent, so the user looks through the display out into their environment.

However, predictive rendering can be applied in other systems too. For example, in certain embodiments, the display is not transparent and blocks the user's view of their environment. In some such cases, such as in certain virtual reality applications, the display presents a virtual environment to the user and presents virtual object 118 as an object in that virtual environment. In other words, the environment perceived by user is generated entirely by the system, e.g., unrelated to the user's actual environment.

In certain applications, such as some augmented reality applications, the display presents an image of the user's actual environment (e.g., generated based on the field of view captured by image capture device 108, overlaying virtual object 118 in the displayed image of the user's actual environment).

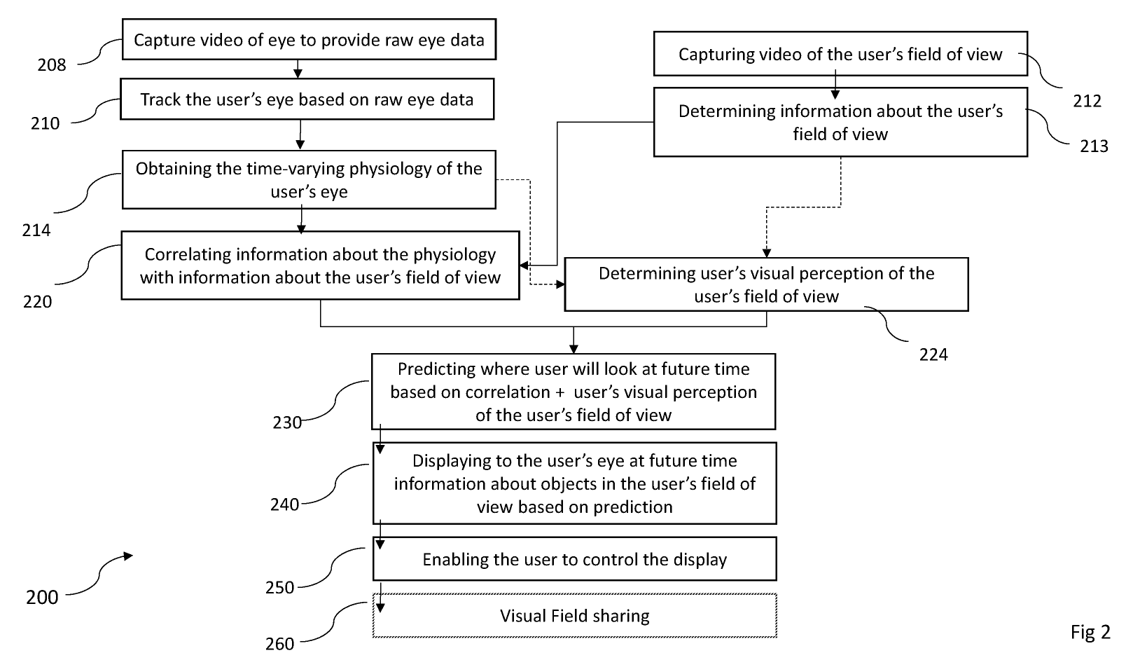

As noted previously, system 100 uses predictive rendering in order to overlay virtual object 118 with physical object 106. FIG. 2 is a flowchart illustrating how a predictive rendering algorithm 200 is implemented using system 100. Raw data is provided by image capture devices 108 and 112. Specifically, in step 208, image capture device 112 captures images of the eye while contemporaneously, in step 212, image capture device 108 collects sequential images of the user's field of view. Both capture devices send the data to the electronic processing module 115.

In step 213, electronic processing module 115 analyzes the information gathered from the user's field of view 104 to determine information about the user's field of view. This information generally includes performing image recognition to identify objects in the field of view (such as physical object 106), but may also include determining additional information such as the activity of the user, such as driving or reading or other contextual information. The electronic processing module 115 may receive additional information about the objects in the user's environment and/or activity from other sensors or information sources (e.g., the internet).

In step 210, electronic processing module 115 tracks the user's eye based on the data from image capture device 112. Typically, eye-tracking involves deriving basic eye data from the images received from image capture device 112. The basic eye data can include gaze coordinates (e.g., 2D); eye coordinates (e.g., x, y, z of the pupil center); pupil data (e.g., area, diameter); and eyelid movements. The basic eye data is determined for each acquired frame. Accordingly, the change of each parameter collected as part of the basic eye data can be tracked by comparing the parameter values from frame to frame.

In step 214, electronic processing module 115 uses the basic eye data to determine the time-varying physiology of the user's eye. In some embodiments, obtaining time-varying physiology includes identifying physiological eye events or status of the user's eye 102, such as gaze events (e.g., fixations, saccades, microsaccades, glissades); gaze vectors; vergence; distance of point of gaze; pupil dilation; and blink events (e.g., intentional blinking, physiological blinking). The time varying physiology can be used to identify both voluntary events (e.g., gaze vector changes) and involuntary events (e.g., saccades, ocular drift, ocular microtremor, nystagmus).

In step 220, the electronic processing module 115 correlates information about the time varying physiology of the user's eye with information gathered about the user's field of view. This correlation indicates, for example, which objects are in the user's central gaze, which objects are in the user's peripheral field of view, and/or objects that are outside the user's field of view.

In some embodiments, correlating the information about the time-varying physiology of the user's eye to information about the user's field of view 220 includes mapping the user's visual field 104 to the captured visual field 110. In augmented reality applications, for example, mapping can be used to ensure that the system 100 displays virtual object 118 of the same physical object 106 or scene 104 as observed by the user. In embodiments in which there is no captured field of view, such mapping is unnecessary (e.g., in certain virtual reality applications). However, correlation between the user's field of view and the time-varying physiology of the user's eye 220 is typically still necessary to understand where the user is looking in the user's field of view 104 and what is located there.

In step 224, the electronic processing module 115 analyzes the time-varying physiology of the user's eye and information about the user's field of view, to determine information about the user's visual perception of the user's field of view. The information about user's visual perception can include, for example, whether the user is focusing on a particular object, is aware of but not focused on an object, or is unaware of an object that is in the user's field of view. In some embodiments, the user's visual perception includes information about whether the user is skimming, reading, or scanning a book, whether the user is focusing, ignoring or analyzing an object in the user's field of view, or whether the user is not alert.

The user's visual perception can be determined based on associations derived from visual neuroscience. For example, increase or decrease in microsaccadic activity can be indicative of a person's emotional state. Accordingly, upon detecting a change in the user's emotional state based on their microsaccadic activity, the system can provide certain information responsive to the change. An example of this is providing information to a surgeon while they perform a surgical procedure. Upon detecting microsaccade activity associated with increased anxiety, the system can provide more information to the surgeon to guide them in the procedure. Conversely, upon detecting decreased anxiety, the system can reduce the amount of assistance, providing the surgeon with reduced information content and a clearer field of view.

As another example, the system may provide information to a shopper while they browse items for sale, either online or in a store. Upon detecting microsaccadic activity associated with aroused or positive emotional state, the system can provide either more information about the item, or competing pricing from other sellers. Upon detecting microsaccadic activity associated with an uninterested emotional state, the system can provide either less information thereby clearing the field of view, or information about other related items that the system has learned the user was previously interested in, for example directing the user to a nearby shelf or aisle with such other items.

As another example, increase or decrease in visual search activity can reveal a person's interest in objects and state of wakefulness or awareness. Accordingly, by concluding that the user is becoming drowsy based on diminishing visual search activity, for example, the system can enhance the appearance of certain objects in the user's field of view in order to bring those objects to the user's attention.

In some embodiments, the electronic processing module 115 may receive additional information about the user's activity from other devices. These devices may include wearable devices, (e.g., a smartwatch of activity tracker), or mobile devices (e.g., a smartphone). The activities may include driving, gaming, playing sports, shopping, or engaging in work. This additional information can be used in the determination of information about the user's visual perception. For example, if the user is driving, this information can cause the algorithm to focus objects in the user's environment relevant to this activity (e.g., road signs, other vehicles, the road, and/or pedestrians or other moving objects). As another example, if the user is playing sports, this information can cause the algorithm to focus on objects relevant to the activity, like other participants, the field of play, and/or a ball or other objects of relevance.

In step 230, electronic processing module 115 uses the correlation determined in 220 and information about the user's visual perception in 224 to predict where the user will look at a future time in 230. As an example, if the user's eye is wobbling, the microprocessor can predict where the eye will look in the user's visual field when the wobble re-stabilizes. In some embodiments, the electronic processing module 115 may determine that the user has not noticed a particular object and predict, therefore, that the user will not focus on that object at a time in the near future.

Generally, the prediction is based on where the user is presently focused, prior voluntary eye motion (where the user was previously looking), and involuntary eye motion. The system can use eye motion over various prior time periods for the predictive rendering. For example, typically, eye motion occurring over the prior few seconds (e.g., the prior 30 seconds or less, the prior 10 seconds or less, the prior 5 seconds or less, the prior 2 seconds or less) can be used to establish the most recent involuntary eye movements and/or to establish the user's level of awareness of objects in their field of view and where their vision is presently focused.

The system can use information about eye motion over longer periods to determine other information about the user that factors into the predictive rendering. For example, changes in involuntary eye motion over minutes or hours can be used to gauge changes in the level of alertness of the user. Saccade frequency, for example, can be indicative of the user's level of alertness.

In some embodiments, Kalman filtering is used to predict where the user will look. A variety of methods can be used to predict where the user will look. Kalman filtering, also known as linear quadratic estimation (LQE), refers to algorithms that use a series of measurements observed over time, containing statistical noise and other inaccuracies, and produce estimates of unknown variables that tend to be more accurate than those based on a single measurement alone. More generally, a variety of predictive algorithms can be used in addition to Kalman filtering, including Bayesian filtering, sequential Monte Carlo sampling (e.g., particle filtering), mean shift procedures, dead reckoning, or alpha-beta-gamma predictors. In some embodiments, machine learning algorithms can be used for the prediction.

In some embodiments, the prediction algorithm can use empirically obtained information correlating the user's eye motion to objects in their field of view. For example, the system can include calibration routines which track the user's eye while controlling the objects in their field of view. Accordingly, certain eye events can be associated unequivocally with visual stimuli. The system calibrates the prediction algorithm based on such measurements. The electronic processing module 115 uses the prediction about where the user will look at a future time to instruct the display device 116. The instructions may include display commands and information about an object in the user's field of view, as derived from internal memory or from another source, such as the internet. The display device 116 displays virtual object 118 to the user's eye 102 in accordance with the instructions at the future time.

In step 250, the user can optionally control the displayed information 118 and/or share the information (step 260), for example via a wireless network. Examples of controlling the displayed information are described below. In some embodiments, the sharing step includes sharing the visual field with other individuals using, for example, a social network.

While algorithm 200 is depicted in FIG. 2 as using information about a single eye, the system can be used to track and analyze information for both eyes. In certain embodiments, the algorithm correlates information gathered from both eyes to determine the user's field of view and plane of focus.

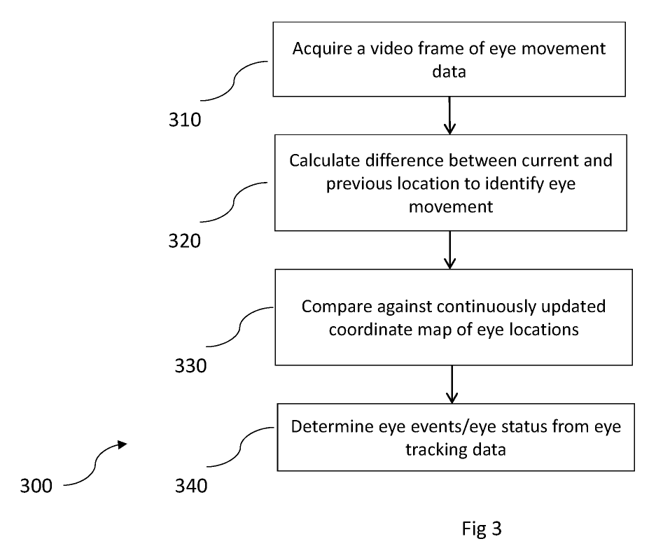

Referring to FIG. 3, exemplary steps 300 of tracking the user's eye (e.g., steps 208-210 in FIG. 2) and obtaining the time-varying physiology of the user's eye (e.g., step 214) are described further. In step 310, image capture device 112 acquires a video frame of the eye. The video frame corresponds to the light reflected from eye 102, as captured by image capture device 112. Next, in 320, the system identifies the current location of a feature of the eye indicative of the state of the eye (e.g., based on edge detection and/or other image analysis techniques) in the frame and compares it to a previous location of the same feature captured and stored by the electronic processing module 115 at an earlier time. The electronic processing module 115 uses the difference between the two locations to determine eye movement.

In some embodiments, the characteristic features of the eye are the pupil location and the location of Purkinje images. Purkinje images are reflections of objects from the structure of the eye. They are also known as Purkinje reflexes and as Purkinje-Sanson images. At least four Purkinje images are usually visible. The first Purkinje image (P1) is the reflection from the outer surface of the cornea. The second Purkinje image (P2) is the reflection from the inner surface of the cornea. The third Purkinje image (P3) is the reflection from the outer (anterior) surface of the lens. The fourth Purkinje image (P4) is the reflection from the inner (posterior) surface of the lens. Unlike the others, P4 is an inverted image. The Purkinje reflections show up as a bright spot in the video image captured by an eye tracking device. P1 and P2 images are easy to detect, while P3 and P4 images are faint and typically require increasing the gain of the image for proper detection.

The system may also similarly identify movement of P1/P2 and P3/P4 Purkinje reflections and use composite data of all three movements to track the eye location.

P3/P4 Purkinje reflections can be faint and difficult to identify. In certain embodiments, the electronic processing module 115 increases the gain or saturation of the raw eye image data collected by capture device 112 to improve identification of P3/P4 reflections. The increase in gain can be achieved by extending the acquisition time or by reduction of frame rate in a very specific sub-locus of the imaged field. For example, the imaged field may have an area of low frame rate (e.g., 10-50 fps, such as about 30 fps) within a larger area of high frame rate (e.g., 200-1,000 fps, such as 500 fps), to target the identification of P3/P4 reflections.

The system may similarly determine other information such as changes in pupil area and eyelid movements based on the difference with historical data. In some embodiments, the system maps the location of a characteristic feature of the eye (e.g., the pupil or a Purkinje reflection) within a pre-established coordinate system. The algorithm continuously updates the map based on new sensor data to trace the trajectory of the eye over time within the coordinate system. In 330, the algorithm uses this coordinate map to compare the currently identified eye location (or other relevant variable) with historical eye data.

In step 340, the system identifies various eye events (e.g., involuntary eye events, such as saccades and microsaccades) and eye status based on the current and prior eye parameter coordinates. For example, the system can combine the three coordinates of eye location (e.g., x, y, z in a Cartesian coordinate system) to determine a gaze vector. In certain embodiments, the eye tracking includes image analysis to identify rapid eye movements, including involuntary eye movements such as nystagmus and microsaccades. This technique may decrease latency between eye movement and the system's response to that movement. For example, a processor, forming part of the electronic processing module 115, may run a series of algorithms to rapidly identify the position of the pupil of the eye, and Purkinje reflections P1/P2 and P3/P4. Other parts of the electronic processing module 115, such as the CPU, may perform longer processing tasks, such as error checking the processor's rapid processing output and checking for any undetected shifts in the position of the pupil and Purkinje images. In some embodiments, shifts in the position of the pupil are detected based on algorithms where the first part of the output (such as a histogram) corresponds to the position of the pupil, the next part of the output corresponds to the position of the iris (represented by P3 and P4), and the peak of the output corresponds to P1, which represents the reflections from the front of the cornea.

In certain embodiments, the system runs on a line-by-line basis. That is, the processor(s) (e.g., FPGA) do not wait for a complete image of the eye to be downloaded and then analyzed (e.g., for the pupil and Purkinje positions). Rather, the processor(s) analyzes each line of the image as it is acquired. This technique may provide an improvement over methods that require full image downloading prior to processing.

By analyzing each line as it comes in, the processor(s) significantly can decrease the processing time and/or increases frame rate. For example, frame rates for capture devices 112 in many conventional eye tracking systems range from 24 to 30 fps. The line-by-line processing of the processor(s), however, provides 10-100 times higher fps rates. Accordingly, in some implementations, high frame rate eye tracking can be performed with no associated lag in rendering that might otherwise accompany conventional image analysis methods. In some embodiments, the images are acquired at a frame rate of 100 fps or greater, or 500 fps or greater, or preferably 1000 fps or greater, preferably 240 to 3000 fps.

In some embodiments, the processor(s) can quickly determine, through line-by-line processing, if a frame should be dumped when it provides information irrelevant for a given task. For example, frames corresponding to blinking, or drooping eyelid or eyelash may be irrelevant for determining the gaze of the user.

Example eye-tracking methods that utilize line-by-line processing are described by J. Lui and A. Dubra in “Low-latency eye tracking for eye motion compensation in high resolution ophthalmoscopy,” Proceedings of the Ninth Biennial ACM Symposium on Eye Tracking Research & Applications, March, 2016.

In certain embodiments, the system uses maps of eye variables to predict where the areas of interest might be. For example, if a particular individual saccades X times per minute to the left at generally Y degrees, the system makes use of that information to predict where the areas of interest will be at any given time. In certain embodiments, if the system identifies an area of interest in pixel location X, Y in the user's field of view 104, the system does not wait for the full image of the user's field of view 104 to download from the first capture device 108, but instructs the display device 116 to display the area of interest to the user right away.

In certain embodiments, the system predicts where future saccades will be. Based on the prediction, the system identifies if the user's gaze is at the predicted location in an image frame. If not, the algorithm begins a line-by-line search to identify the gaze location.

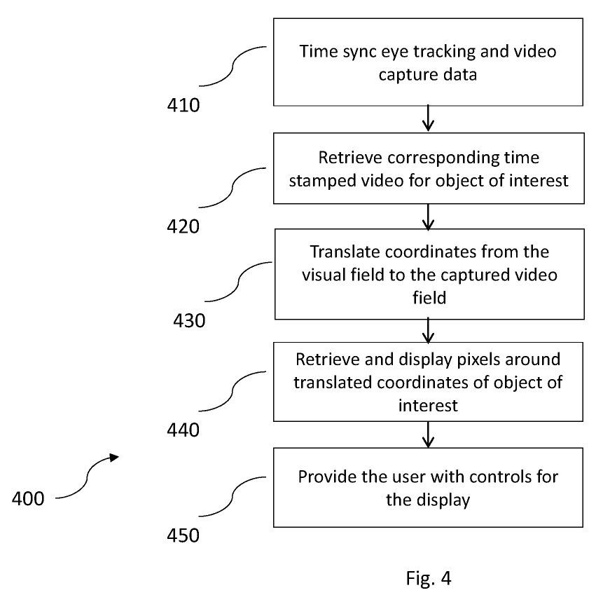

FIG. 4 illustrates an exemplary mapping function performed by the system to enhance an image of an object of interest 106 to the user 102, e.g., in an augmented reality application. In the first step 410, the system time syncs eye tracking data derived from capture device 112 and video capture data from device 108. The system determines the coordinates of the user's visual field based on eye tracking data. The system also predicts, as detailed above, when a person is interested in a particular object or area within the user's visual field and would like to see it enhanced. For example, a user may indicate interest by pausing to look at an object for a specified “hold period” or “stare duration.” In one embodiment, a user's interest in an object prompts the algorithm to time stamp the corresponding captured field of view video frame. The algorithm retrieves the time stamped video, as shown in step 420.

Next, in step 430, the system translates (“maps”) the coordinates of a person's visual field to those of the time stamped video field. The system uses block processing and edge detection techniques to remove unwanted pixels in the stamped video field and retrieves the pixels related only to the object or area of interest. Edge detection refers to a set of mathematical methods which aim at identifying points in a digital image at which the image brightness changes sharply or, more formally, has discontinuities. These mathematical methods may thus be used to analyze every pixel in an image in relation to the neighboring pixels and select areas of interest in a video field, while eliminating the non-relevant pixels. Relevant image processing techniques include Canny edge detection, first-order methods, thresholding and linking, edge thinning, second-order approaches such as differential edge detection and phase congruency-based edge detection.

Such image processing may save bandwidth if the algorithm needs to use the processed image (instead of the entire captured image) to retrieve information from the Internet or the user chooses to share the image over social media.

In step 440, after image processing, the display device 116 displays the processed virtual object 118 to the user. Thereafter, the user can manipulate the displayed object or scene, as shown in 450. Exemplary controls for manipulating the display include rewind, zoom, pan, change contrast, brightness, color, hue, etc. For certain enhancement manipulations, including zooming, the capture device 116 used may be a high definition camera able to capture a person's entire visual field in greater detail than human eyesight allows.

In some embodiments, the system continuously maps the user's visual field to the captured video field, instead of at specific time stamps as described above. In some embodiments, the system establishes a universal coordinate system at the beginning of use and each captured video frame is analyzed based on that universal system. The system can use accelerometers, magnetometers, and gyroscopes to determine the location of the person's head in the universal coordinate system. The system can determine the location of the person's gaze in the universal coordinate system with eye tracking.

As discussed above, with the system can include controls to manipulate a virtual object 118 displayed to the user. These controls may include functions such as rewind, zoom, pan, etc., lighting enhancements, face recognition or identification, as well as the option to change the visual acuity (for example from normal to enhanced) and also to change the scene being viewed. As detailed above, the system can retrieve relevant video fields or portions of a video field and display them in accordance with user inputs.

User control inputs may include interaction via a mobile phone linked to the visual interface device, physical interaction with visual interface device (e.g., tapping), hand gestures, and voice commands. Any of these interactions, either alone or in combination, can be used to initiate a search for something within the visual field, obtain information on something in the visual field, zoom within the visual field, etc.

In some embodiments, the system 100 can allow a user to find an object in a defined area. For example, the system can include a dedicated mode of operation, accessible by the user, to locate an object of interest. The user then uses the field of view image capture device to scan the area visually. In augmented reality implementations, this can correspond to the user simply visually scanning the area with the system set to the appropriate mode of operation. The system processes the scanned video using an image recognition algorithm to find the identified object (car, keys, etc.) and displays instructions to the user. For example, the system can highlight the object of interest's location in the user's field of view. Alternatively, or additionally, the system can display instructions to the user indicating where the user needs to position their visual field in order to see the desired object.

In some embodiments, the system 100 can allow a user to improve their view of something in a defined area. For example, the system can include a dedicated mode of operation, accessible by the user, to enhance an area in the field of view. The user then uses the field of view image capture device to focus at a specific area in the field of view. In augmented reality implementations, this can correspond to the user visually focusing on a specific area for a set “stare duration,” with the system set to the appropriate mode of operation. The system time stamps the captured video field corresponding to the user's area of interest and displays it to the user. The user is then able to enhance the field as detailed above (e.g., zooming, panning, changing contrast, brightness, color, hue, etc.).

In some embodiments, the system can allow a user to contemporaneously share a captured still image or video of the visual field with someone else. For example, the system can include a dedicated mode of operation, accessible by the user, to share a field of view. The user then uses the field of view image capture device to scan and simultaneously share the area visually. In augmented reality implementations, this can correspond to the user simply visually scanning the area with the system set to the appropriate mode of operation. The other users receiving that shared video can then manipulate it using all the same video processing techniques as the original user.

In some embodiments, the system allows a user to perform sharing over standard social networks. Users can select to share the captured field with a defined group of friends or to post it publically. Thus, for example, if the user is attending a popular or famous event, the user can share their video field captured by the interface.

In some embodiments, predictive rendering can be used to stabilize a displayed virtual object by removing effects of involuntary eye wobble. For example, the system can use eye tracking data, including the location of the pupil and Purkinje reflections P1/P2 and P3/P4, to determine a degree of lens wobble for the eye and to digitally stabilize an image to mitigate the effects of the lens wobble. Lens wobble is a natural phenomenon of the eye and the degree of wobble is, in general, characteristic of an individual. It typically occurs because of the inherent anatomy of the iris and the retaining lens fibers (called zonules) emanating from the ciliary body. In some cases, tissues supporting the lens may lose their flexibility as people age, and become stiffer, thereby decreasing the wobble. In other people with aging or in certain diseases the zonules themselves weaken, leading to increased wobble (called “phacodonesis” in extreme cases of loose lenses).

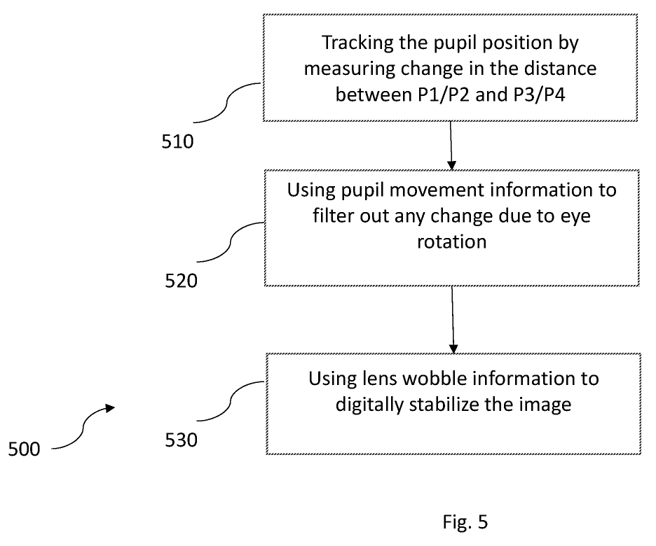

FIG. 5 shows a flowchart detailing a method of determining lens wobble and stabilizing an image based on the determined wobble information using predictive rendering. In the first step 510, the system determines the change in the distance between P1/P2 and P3/P4 from raw eye data. This distance can change because of eye rotation or because of the lens wobble itself. The change in the distance between P1/P2 and P3/P4 is independent of any head movement or other movements, thus making it more resilient to noise.

In the next step 520, the system filters out any change in the distance between P1/P2 and P3/P4 due to eye rotation by adjusting the P1/P2 to P3/P4 distance based on acquired pupil movement data. In certain embodiments, pupil location information is combined with P1 data to filter out change due to eye rotation. Using P1 may yield more accurate eye rotation information than using pupil movement alone.

Finally, in step 530, the system uses the lens wobble information obtained from the previous step to digitally stabilize the virtual object 118 displayed by device 116.

In certain embodiments, the system predicts, based on prior wobble data, the final position of the eye at the end of an eye wobble without tracking the eye for the entire length wobble. In certain embodiments, wobble might be calibrated once by estimating the “spring” constants of the eye for horizontal and vertical rotation. From then on, the wobble can be calculated by only tracking the pupil or iris inner and/or outer boundary, by assuming that the eye rotation is similar to that of a damped linear oscillator (sinusoidal oscillation/rotation with exponential amplitude reduction). In some embodiments, the system instructs the display device 116 to show the user the virtual object 118 at the predicted end time of the wobble, at the predicted eye location at that time, instead of instructing the display to “chase” the user's eye for the length of the wobble.

In some embodiments, the adjustment for lens wobble are based on a user's specific eye anatomy and condition and desired image quality. In certain embodiments, eye tests are conducted to determine how patient's eye perceives images in field of view. Testing may include digital mapping of the eye through the use of medical scanning devices. Physical characteristics and abnormalities of the tested eye are mapped in order to provide a complete anatomical map. The degree of lens wobble in the image can then adjusted based on the individual's eye anatomy and the desired visual acuity.

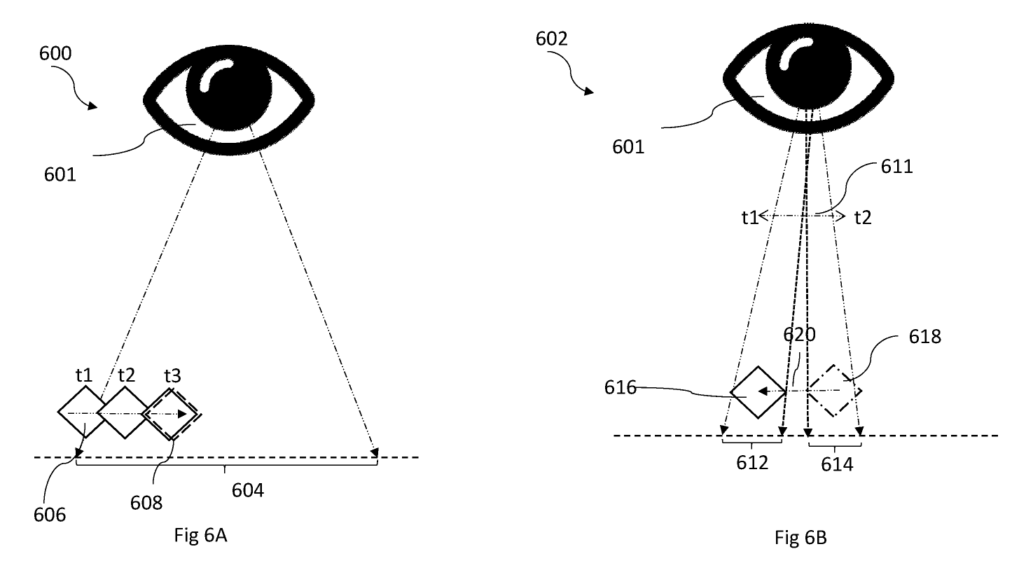

FIGS. 6A-6B illustrate two further examples of how predictive rendering can be used with a visual interface system. Referring to FIG. 6A, the visual interface 600 warns a user about an object 606 that is in the periphery of the user's field of vision 604 of eye 601. At time t1, object 606 is at the edge of the user's visual field 604, moving into the field of view. This motion is illustrated by the object's position at subsequent times t2 and t3. Based on the position of object 606 at times t1 and t2, and eye tracking data at times prior to t3, the system renders a virtual image 608 to highlight object 606 for the user at t3. Such rendering can be useful, for example, where the system determines, based on prior eye motion and visual neuroscience information, that the user has not noticed object 606 and concludes that the object should be brought to the user's attention.

Referring to FIG. 6B, predictive rendering can optimize how a visual interface system overlays displayed information with an object in the user's field of view. Here, system 602 uses tracked eye motion in a feedback arrangement to effect optimal alignment of a virtual object 618 with a physical object 616 in the user's field of view. Specifically, when virtual object 718 is displaced from physical object 616 in the user's field of view (e.g., overlay is imperfect), the user's eye 601 can saccade 611 between two points of focus 612 and 614 corresponding to the locations of object 616 and virtual object 618, respectively. The system detects the eye movement associated with the saccades and associates the saccades with the misalignment (e.g., based on visual neuroscience information). In response, the system changes the location of virtual object 618 in a manner that reduces the amplitude of the associated saccade until the saccades have been minimized. Minimizing overlay mismatching can be useful for both augmented and virtual reality implementations.

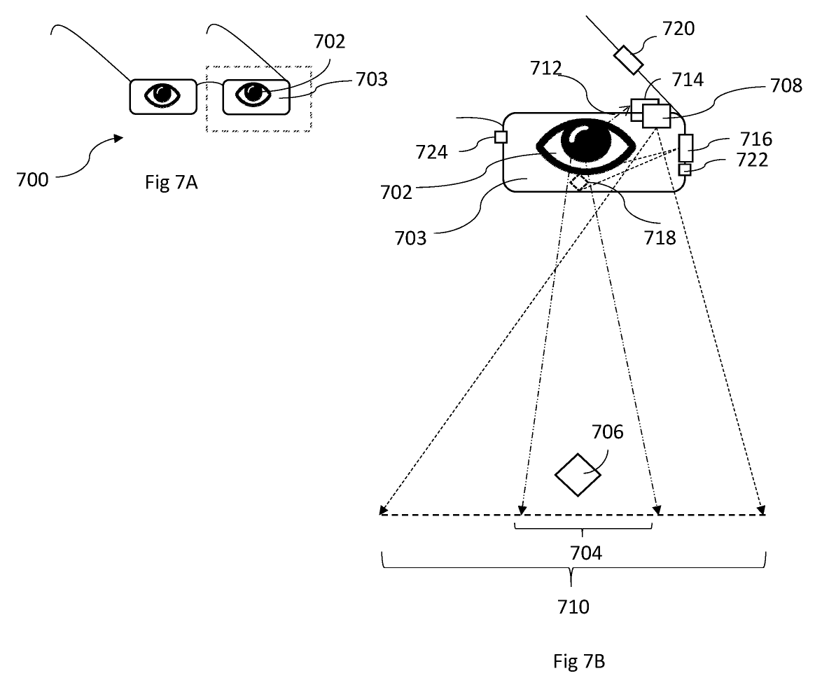

In general, system 100 can be implemented in a variety of form factors. The display devices, batteries, image capture devices, and processors discussed may be configured in different arrangements to balance or optimize considerations such as efficiency, user comfort, weight, processing speed, etc. These systems can take advantage of recent developments in the technology industry including smaller, faster and more economical microprocessors, smaller micro-display and projection technologies which allow for the manipulation of single pixels, wave-guide optics, improved image capture, and enhanced battery technologies. In some implementations, the visual interface system is configured as smart eyeglasses. For example, FIGS. 7A and 7B show a smart eyeglasses system 700. The system 700 includes a lens 703, image capture devices 708 and 714, as well as an electronic processing module. Focusing on a single eye in FIG. 7B, that eye 702 faces a lens 703. Image capture device 708 mounted on the frame of the lens captures a field of view 710 that overlaps with the eye's field of view 704. The second image capture device 714 also mounted on the frame of the lens collects raw eye data 712. The electronic processing module 720 mounted on the earpiece collects inputs from capture devices 708 and 714, analyzes the data, and delivers instructions to the display device 716 based on a predictive rendering algorithm to change or enhance the displayed object 718 at some future time.

The display device 716 displays the image 718 to the user's eye 702. In certain embodiments, the image 718 may be only an overlay of the real object 706 the user observes through lens 703. In certain embodiments, the display device 716 displays to the user's eye 702 the user's entire field of view 704. The user thus sees a virtual reproduction of object 706, along with any augmenting overlay image 718.

In some embodiments, both lenses 703 have the functionality described above. In some embodiments, only a single lens has that functionality. In some embodiments, the glasses 700 display the same overlay image 718 to both eyes simultaneously. In some embodiments, the algorithm 200 computes an optimal method of displaying image 718 to both eyes, avoiding double-vision effects.

The display device 716 may work with a digital or optical waveguide, reflector or other optical device to distribute the processed image 718 to the eye 702. In certain embodiments, the display device 716 projects the image 718 onto the lens 703 of the eyeglasses. In certain embodiments, the eyeglasses 700 have an optical or digital wave-guide that directs the image 718 to the planar lenses 703 of the eyeglasses. The waveguide may be positioned on the lens 703 or around the lens 703.

The display device 716 may also directly project the image 718 into the eye 702. In certain embodiments, a reflector mounted on the inside of the eyeglass frame may be used to direct the image 718 from a projector to the eye 702.

A battery or other power source 724 with charging capabilities drives the power requirements of various components of the system. In some embodiments, the battery is a rechargeable nanobattery.

Input controls 722 allow the user to communicate with the display device 716 to change or enhance the displayed image 718 as detailed above. Physical placement of the processor 720, battery 724, and capture devices 708 and 714 may be altered based on various constraints, such as balance of the frames, user comfort, etc. The microprocessor 720 may include multiple processors and one or more non-volatile memories. The microprocessor 720 or display device 716 may include wireless capabilities to transmit and receive information to and from the Internet.

The smart eyeglasses 700 may be useful to correct vision impairments, such as enhancing the fovea and peripheral views, allowing generated signals to be delivered to the eye in a manner that image processing is carried out by the brain. In some embodiments, the predictive algorithm 200 may use information about how a specific individual sees and send instructions to the display device 716 to provide a corrected and enhanced set of visual signals 718.

In some embodiments, the functionality of smart eyeglasses can be integrated into contact lenses.

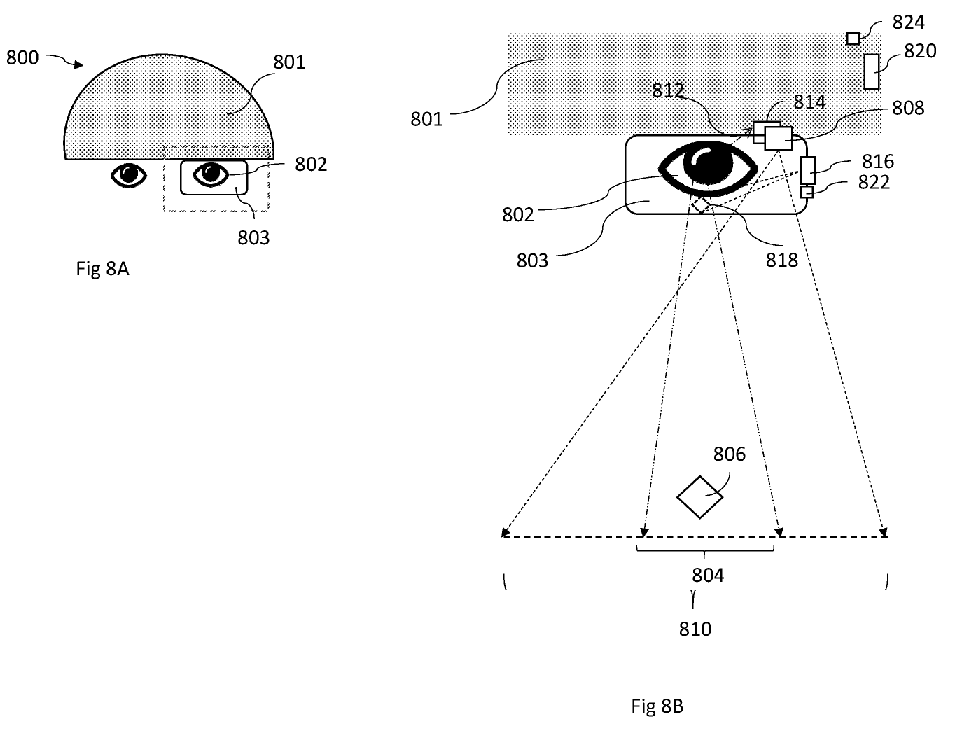

Referring to FIGS. 8A and 8B, in some embodiments visual interface systems are implemented as a head mounted system 800. System 800 is mounted (at least in part) on a helmet 801 and includes a display 803, image capture devices 808 and 814, as well as an electronic processing module 820 embedded in helmet 801. One of the eyes faces a planar display 803 mounted to a helmet 801. Image capture device 808 captures a field of view 810 that overlaps with the eye's field of view 804. Image capture device 814 collects raw eye data 812. Electronic processing module 820 collects input from the capture devices 808 and 814, analyzes the data, and delivers instructions to the display device 816 based on a predictive rendering algorithm. A battery or other power source 824 with charging capabilities drives the power requirements of various components of the system. The user can use an input control 822 that communicates with the display device 816 to change or enhance the displayed object 818.

In certain embodiments, the image 818 may be only an overlay of the real object 806 the user observes through display 803. In certain embodiments, the display device 816 displays to the user's eye 802 the user's entire field of view 804. The user thus sees a virtual reproduction of object 806, along with any augmenting overlay image 818.

In some embodiments, system 800 includes displays for both of the user's eyes.

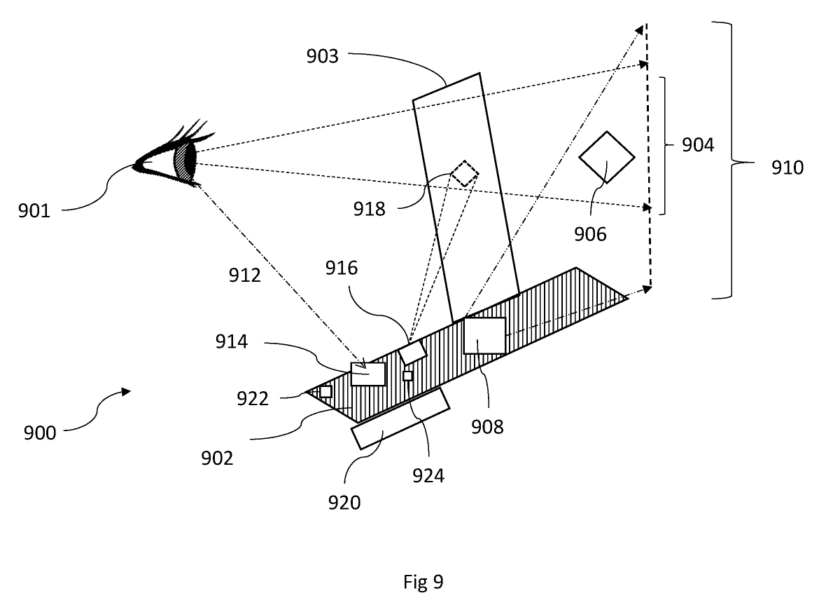

Referring to FIG. 9, in some embodiments visual interface systems are implemented as a dashboard heads up system 900. System 900 is embedded (at least in part) into dashboard 902, and includes a windshield 903, image capture devices 908 and 914, as well as an electronic processing module 920 embedded in dashboard 902. While driving, the user's eyes 901 face windshield 903. Image capture device 908 embedded in dashboard 902 captures a field of view 910 that overlaps with the eye's field of view 904. Image capture device 914 embedded in dashboard 902 collects raw eye data 912. Electronic processing module 920 collects input from the capture devices 908 and 914, analyzes the data, and delivers instructions to the display device 916 based on a predictive rendering algorithm. The display device 916 projects images 918 onto the windshield 903. In certain embodiments, the display device projects an image 918 onto a separate screen or directly into the user's eyes. The image 918 is an overlay of the real object 906 the user observes through windshield 903.

A battery or other power source 924 embedded into the dashboard drives the power requirements of various components of the system. The user can use an input control 922 that communicates with the display device 916 to change or enhance the displayed information 918.

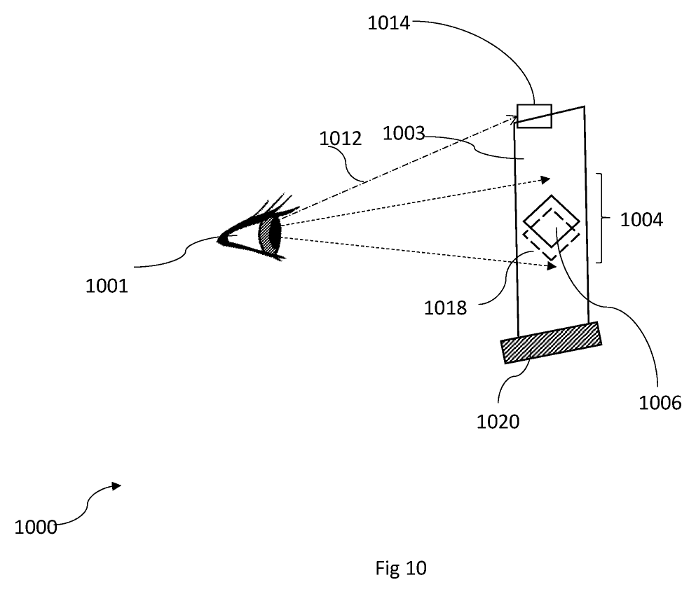

In general, visual interface systems can be integrated into non-immersive environments such as watching television or using a computer, laptop, tablet, or mobile device. Referring to FIG. 10, in some embodiments visual interface systems are implemented as a computer screen system 1000. System 1000 includes a monitor 1003, an image capture device 1014, as and an electronic processing module 1020 integrated with the monitor 1003. A user's eye 1001 faces the monitor 1003. The image capture device 1014 collects raw eye data 1012. The electronic processing module 920 collects input from the capture device 1014 and monitor 1003, analyzes the data, and delivers instructions to the monitor 1003 based on a predictive rendering algorithm. The monitor 1003 displays the image 1018 according to the instructions. In certain embodiments, the image 1018 is an overlay of the virtual object 1006 the user observes on monitor 1003.

In some embodiments, the system is programmed to use the user's gaze to move the cursor on the screen 1003 or to instruct the display 1003 to enhance certain objects. In certain embodiments, if the user's gaze is used to move a cursor, the system uses a low pass filter to filter out the predicted motions of the eye to prevent improper movement of the cursor.

Aspects of the systems and methods described here can be implemented in digital electronic circuitry, or in computer software, firmware, or hardware, including the structures disclosed in this specification and their structural equivalents, or in combinations of one or more of them. For example, in some implementations, the algorithms disclosed above can be executed using digital electronic circuitry, or in computer software, firmware, or hardware, or in combinations of one or more of them.

In general, the term “electronic processing module” encompasses all kinds of apparatus, devices, and machines for processing data and/or control signal generation, including by way of example a programmable processor, a computer, a system on a chip, or multiple ones, or combinations, of the foregoing. The module can include special purpose logic circuitry, e.g., an FPGA (field programmable gate array) or an ASIC (application specific integrated circuit). The module can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The module and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes described above can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a flat panel display, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computing system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

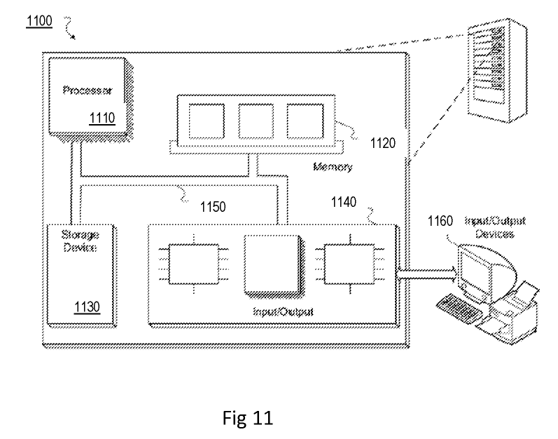

FIG. 11 shows an example electronic processing module 1100 that includes a processor 1110, a memory 1120, a storage device 1130 and an input/output device 1140. Each of the components 1110, 1120, 1130 and 1140 can be interconnected, for example, by a system bus 1150. The processor 1110 is capable of processing instructions for execution within the system 1100. In some implementations, the processor 1110 is a single-threaded processor, a multi-threaded processor, or another type of processor. The processor 1110 is capable of processing instructions stored in the memory 1120 or on the storage device 1130. The memory 1120 and the storage device 1130 can store information within the module 1100.

The input/output device 1140 provides input/output operations for the module 1100. In some implementations, the input/output device 1140 can include one or more network interface devices, e.g., an Ethernet card, a serial communication device, e.g., an RS-232 port, and/or a wireless interface device, e.g., an 802.11 card, a 3G wireless modem, a 4G wireless modem, a LTE wireless modem, etc. In some implementations, the input/output device can include driver devices configured to receive input data and send output data to other input/output devices, e.g., keyboard, printer and display devices 1160. In some implementations, mobile computing devices, mobile communication devices such as smart phones or tablet computers, and other devices can be used.

The above examples are merely illustrative of the many applications of the systems, methods, and apparatuses of the disclosure. It should be noted herein that any feature or component described in association with a specific embodiment may be used and implemented with other embodiments unless clearly indicated otherwise. Accordingly, other embodiments are in the following claims.

What is claimed is:

1. A method of displaying information to a user, comprising:
tracking the user's eye to obtain information about the time-varying physiology of the user's eye;
correlating the information about the time-varying physiology of the user's eye to information about the user's field of view;
predicting where the user will look at a future time based on the correlation; and
displaying to the user's eye, at the future time, information related to one or more objects in the user's field of view based on the prediction.

2. The method of claim 1, wherein predicting is additionally based on information about the user's visual perception of the user's field of view.

3. The method of claim 1 or 2, wherein predicting comprises using a predictive algorithm.

4. The method of claim 3, wherein the algorithm comprises Bayesian filtering, Kalman filtering, sequential Monte Carlo sampling, mean shift procedures, dead reckoning, or alpha-beta-gamma predictors.

5. The method of claim 1, wherein tracking the user's eye comprises acquiring a sequence images of the user's eye and determining, from the images, information selected from the group consisting of: gaze coordinates; eye coordinates; pupil data; and eyelid movements.

6. The method of claim 5, wherein obtaining information about the time-varying physiology of the user's eye comprises identifying physiological events and status of the user's eye based on the information determined from the sequential images.

7. The method of claim 6, wherein the physiological events and status comprise voluntary eye movements.

8. The method of claim 6, wherein the physiological events and status comprise involuntary eye movements.

9. The method of claim 6, wherein the physiological events and status comprise events and status selected from the group consisting of: gaze events; gaze vectors; vergence; distance of point of gaze; pupil dilation; and blink events.

10. The method of any one of claims 5-9, wherein the images are acquired at a frame rate sufficient to track microsaccades and nystagmus of the user's eye.

11. The method of any one of claims 5-10, wherein the images are acquired at a frame rate of 24 frames-per-second or greater.

12. The method of any one of claims 5-11, wherein the images are acquired at a frame rate in a range from 24 frames-per-second to 100 frames-per-second.

13. The method of any one of claims 5-12, wherein the images are analyzed line-by-line to provide the information about the time-varying position of the eye.

14. The method of any one of claims 6-13, wherein correlating the information about the time-varying physiology of the user's eye to the user's field of view comprises acquiring a sequence of images of the user's field of view and correlating one or more objects in each image of the user's field of view to physiological events and status of the user's eye at the corresponding time.

15. The method of claim 14, wherein correlating the one or more objects comprises identifying, at each corresponding time, an object that is a subject of the user's gaze and/or one or more objects that are in the user's peripheral vision.

16. The method of claim 15, wherein predicting where the user will look at the future time comprises predicting which of the objects will be the subject of the user's gaze at the future time and which of the objects will be in the user's peripheral vision at the future time.

17. The method of claim 16, wherein the information displayed to the user's eye at the future time comprises information related to the object predicted to be the subject of the user's gaze at the future time.

18. The method of claim 16, wherein the information displayed to the user's eye at the future time comprises information related to the object predicted to be in the user's peripheral vision at the future time.

19. The method of any one of claims 14-18, wherein the objects in each image of the user's field of view are virtual objects rendered by an electronic display.

20. The method of any one of claims 14-18, wherein the objects in each image of the user's field of view are real objects.

21. The method of any one of claims 14-20, wherein displaying the information to the user's eye comprises overlaying images with one or more objects in the user's field of view.

22. The method of any one of claims 6-21, wherein where the user will look at a future time is predicted based on the identified physiological events and status of the user's eye.

23. The method of any one of claims 5-22, wherein tracking the user's eye comprises identifying Purkinje reflections in the sequentially-acquired images and tracking the motion of the Purkinje reflections.

24. The method of any one of the preceding claims, wherein the information is displayed based on contextual user information in addition to the prediction.

25. The method of claim 24, wherein the contextual user information is derived from one or more images of the user's field of view.

26. The method of any one of claims 24-25, wherein the contextual user information comprises information about the user's activity contemporaneous to displaying the image.

27. The method of any one of the preceding claims, wherein both of the user's eyes are tracked.

28. The method of any one of the preceding claims, wherein the information is displayed to the user's eye in a virtual reality environment.

29. The method of any one of the preceding claims, wherein the information is displayed to the user's eye in an augmented reality environment.

30. The method of any one of the preceding claims, wherein the method is implemented using a device selected from the group consisting of: a laptop computer; a tablet computer; a mobile phone; a personal computer; a personal data assistant; a smartphone; a head mounted display; and a heads-up display.

31. The method of any one of the preceding claims, wherein the displayed information related to one or more objects in the user's field of view enhances the one or more objects in the user's field of view.

32. The method of any one of the preceding claims, wherein tracking the user's eye comprises determining lens wobble for the user's eye and displaying the information comprises stabilizing a displayed image to compensate for the lens wobble.

33. A system, comprising:
an electronic display module arranged to display information to a user's eye related to one or more objects in the user's field of view during operation of the system;
an eye-tracking module arranged to obtain information about a time-varying physiology of the user's eye during operation of the system; and
an electronic control module in communication with the electronic display module and the eye-tracking module, the electronic control module being programmed to:
(i) correlate the information about the time-varying physiology of the user's eye from the eye-tracking module to the user's field of view;
(ii) predict where the user will look at a future time based on the correlation; and
(iii) cause the electronic display module to display to the user's eye, at the future time, information related to one or more objects in the user's field of view based on the prediction.

34. The system of claim 33, wherein the electronic control module is further programmed to predict where the user will look based on information about the user's visual perception of the user's field of view.

35. The system of any one of claims 33-34, wherein the electronic control module is programmed to use a predictive algorithm for the prediction.

36. The system of claim 35, wherein the algorithm comprises Bayesian filtering, Kalman filtering, sequential Monte Carlo sampling, mean shift procedures, dead reckoning, or alpha-beta-gamma predictors.

37. The system of any one of claims 33-36, further comprising an image capture module arranged to acquire a sequence of images of the user's field of view.

38. The system of claim 37, wherein the image capture module comprises one or more image sensors arranged to capture an image of the user's field of view during use of the system.

39. The system of any one of claim 33-38, wherein the eye-tracking module comprises an image sensor arranged to acquire a sequence of images of the user's eye.

40. The system of claim 39, wherein the electronic control module is further programmed to determine, from the images of the user's eye, information selected from the group consisting of: gaze coordinates; eye coordinates; pupil data; and eyelid movements.

41. The system of any one of claim 39-40, wherein the information about the time-varying physiology of the user's eye comprises physiological events and status of the user's eye based on the information determined from the sequential images.

42. The system of claim 41, wherein the physiological events and status comprise voluntary eye movements.

43. The system of claim 41, wherein the physiological events and status comprise involuntary eye movements.

44. The system of claim 41, wherein the physiological events and status comprise events and status selected from the group consisting of: gaze events; gaze vectors; vergence; distance of point of gaze; pupil dilation; and blink events.

45. The system of any one of claims 39-44, wherein the image sensor is arranged to acquire a sequence of images at a frame rate sufficient to track microsaccades and nystagmus of the user's eye.

46. The system of any one of claims 39-45, wherein the image sensor is arranged to acquire a sequence of images at a frame rate of 24 frames-per-second or greater.

47. The system of any one of claims 39-45, wherein the image sensor is arranged to acquire a sequence of images at a frame rate in a range from 24 frames-per-second to 100 frames-per-second.

48. The system of any one of claims 39-47, wherein the electronic control module is programmed to analyze the images line-by-line to obtain the information about the time-varying position of the eye.

49. The system of claim 38, wherein being programmed to correlate the information about the time-varying physiology of the user's eye to the user's field of view comprises being programmed to correlate one or more objects in each image of the user's field of view to physiological events and status of the user's eye at the corresponding time.

50. The system of claim 49, wherein being programmed to correlate the one or more objects comprises being programmed to identify, at each corresponding time, an object that is a subject of the user's gaze and/or one or more objects that are in the user's peripheral vision.

51. The system of claim 50, wherein the electronic control module being programmed to predict where the user will look at the future time comprises being programmed to predict which of the objects will be the subject of the user's gaze at the future time and which of the objects will be in the user's peripheral vision at the future time.

52. The system of claim 51, wherein the information related to one or more objects in the user's field of view comprises information related to the object predicted to be the subject of the user's gaze at the future time.

53. The system of claim 52, wherein the information related to one or more objects in the user's field of view comprises information related to the object predicted to be in the user's peripheral vision at the future time.

54. The system of any one of claims 49-53, wherein the objects in each image of the user's field of view are virtual objects rendered by an electronic display.

55. The system of any one of claims 49-53, wherein the objects in each image of the user's field of view are real objects.

56. The system of any one of claims 49-55, wherein the electronic display module is configured to overlay images with one or more objects in the user's field of view.

57. The system of claim 56, wherein the electronic control module is programmed to predict where the user will look at a future time based on the identified physiological events and status of the user's eye.

58. The system of any one of claim 39-48, wherein the system is programmed to identify the Purkinje reflections in the sequentially-acquired images and to track the motion of the Purkinje reflections.

59. The system of any one of claims 49-56, wherein the electronic control module is programmed to predict where the user will look at a future time based on contextual user information.

60. The system of claim 59, wherein the contextual user information is derived from one or more images of the user's field of view.

61. The system of any of claims 59-60, wherein the contextual user information comprises information about the user's activity contemporaneous to displaying the image.

62. The system of any one of claims 33-61, wherein the eye-tracking module if arranged to obtain information about both of the user's eyes.

63. The system of any one of claims 33-62, wherein the system is arranged to operate in a virtual reality environment.

64. The system of any one of claims 33-63, wherein the system is arranged to operate in an augmented reality environment.

65. The system of any one of claims 33-64, wherein the information related to one or more objects in the user's field of view enhances the one or more objects in the user's field of view.

66. The system of claim 38, further comprising a wearable device which comprise the one or more digital image sensors.

67. The system of any one of claims 33-66, wherein the electronic control module comprises a FPGA or ASIC arranged to process signals from the eye-tracking module.

68. The system of claim 67, wherein the electronic control module further comprises a central processing unit arranged to process signals from the FPGA or ASIC.

69. The system of any one of claims 33-68, wherein the electronic display module comprises a head-mounted display.

70. The system of claim 69, further comprising a wearable device which comprise the head-mounted display.

71. The system of any one of claims 33-70, wherein the electronic display module comprises a projector arranged to direct projected light to a reflector positioned in an eyepiece of the wearable device, the reflector being arranged to reflect the projected light to the user's eye to present the images to the user's eye.

72. The system of any one of claims 33-71, wherein the electronic display module comprises a projector arranged to direct projected light to a waveguide positioned in an eyepiece of the wearable device, the waveguide being arranged to direct the projected light to the user's eye to present the images to the user's eye.

73. The system of any one of claims 33-72, further comprising a wearable device comprising the image sensor of the eye-tracking module.

74. The system of any one of claims 33-53, 55-62, 64-73, wherein the system is an augmented reality system.

75. The system of any one of claims 33-37, wherein the system is a virtual reality system.

76. The system of claim 37, wherein the system is integrated into a motor vehicle comprising a steering wheel, a windshield, a dashboard, and side windows.

77. The system of claim 76, wherein the user's field of view comprises the scene observable to a driver through the vehicle's windshield and windows.

78. The system of any one of claims 76-77, wherein the eye-tracking module is embedded in the steering wheel or the dashboard of the vehicle.

79. The system of any one of claims 76-78, wherein the image capture module is embedded in the steering wheel or dashboard of the vehicle.

80. The system of any one of claims 76-79, wherein the display module projects images onto the windshield of the vehicle.

81. The system of any one of claims 76-80, wherein the display module is a heads-up display attached to the dashboard and positioned in front of the windshield.

82. The system of claim 33, wherein the electronic display module comprises a display of a device selected from the group consisting of: a laptop computer; a tablet computer; a mobile phone; a personal computer; a personal data assistant; or a smartphone.

83. The system of claim 82, wherein the eye-tracking module is arranged to face the user of the display.
